(19) United States
(12) Patent Application Publication
(10) Pub. No.: US 2005/0176300 A1
(43) Pub. Date: Aug. 11, 2005

(54) Grounding structure of an electrical connector

(75) Inventors: I-Chang Hsu, Taipei Hsien (TW); Fu-Chen Chou, Taipei Hsien (TW); Pi-Ching Chen, Taipei Hsien (TW)

Correspondence Address: BRUCE H. TROXELL, SUITE 1404, 5205 LEESBURG PIKE, FALLS CHURCH, VA, 22041, US

(73) Assignee: Comax Technology Inc.

(21) Appl. No.: 10/815,688

(22) Filed: Apr. 2, 2004

(30) Foreign Application Priority Data
Feb. 11, 2004 (TW) 093201909

(51) Int. Cl. H01R 9/03

(52) U.S. Cl. 439/610

(57) ABSTRACT

The present invention relates to a grounding structure of an electrical connector suitable for high frequency transmitting. The high frequency connector mainly has a connecting part being combined with a plurality of grounding lines to improve the electrical characteristics of the high frequency connector when it transmits a signal. Wherein, the connecting part further comprises a wing portion and a protrusion portion; thereby the connecting part can engage the grounding terminals with the grounding line of the cable to form electrical contact. Furthermore, one end of the connecting part is extended directly and comprises predetermined grounding terminals, such that the grounding line can be directly connected to connecting part; such as, the electrical connector can have better electrical characteristics and the grounding line can directly be coupled to the grounding terminals without the soldering process by using aforesaid structure, meanwhile, the entire assembly process and the relative cost can be lessened.

### BACKGROUND OF THE INVENTION

1. Field of the Invention

The present invention relates to a grounding structure of an electrical connector suitable for high frequency transmitting. The high frequency connector mainly has a connecting part being combined with a plurality of grounding lines to improve the electrical characteristics of the high frequency connector when it transmits a signal, and the grounding line of the high frequency connector can directly be coupled to the grounding terminals without a soldering process such that the entire assembly process and the relative cost can be lessened.

2. Description of the Related Art

Generally, most grounding structure of the prior art connector used on the motherboard of the computer mainly is soldered directly to the grounding line and the grounding terminals, however, due to the science and technology increasing continuously and the environmental protection sense raising, the assembly process of the electronic industry is leading to lead-ness process progressively.

One of the grounding structures of the prior art connector has been found in the U.S. Pat. No. 6,489,563 B1 patent, wherein, the patent uses a grounding sleeve as a contact between the grounding line and grounding terminals; however, the grounding sleeve still needs to be soldered to the grounding terminals so as to form electrical contact.

However, the grounding design of the connector according to the U.S. Pat. No. 6,489,563 B1 patent may improve the electrical characteristics, but it has no contribution to the environmental protection considering and assembly process; besides it easily generates environmental pollution during the soldering process, it also easily causes departing effect if the soldering process is not complete or not certain, further, decreases the grounding effect and electrical characteristics; meanwhile, the assembly structure of the prior art not only increases the cost and wastes man power, but has a poor yield rate, such that the manufacturing cost is increased for no reason and does not conform to cost effectiveness.

### SUMMARY OF THE INVENTION

According to one aspect of the present invention, the present invention provides a high frequency connector with an easy connecting part, which overcomes some, or all of the previously delineated drawbacks of the prior art connector that makes the connector to have the best electrical characteristics.

For reaching the aforesaid object, wherein, the connecting part comprises a wing portion and a protrusion portion; thereby the connecting part can engage the grounding terminals with the grounding line of the cable to form electrical contact. Furthermore, one end of the connecting part is extended directly and comprises predetermined grounding terminals, such that the grounding line can be directly connected to the connecting part; such as, the electrical connector can have better electrical characteristics and the grounding line can directly be coupled to the grounding terminals without the soldering process by using the aforesaid structure, meanwhile, the entire assembly process and the relative cost can be lessened.

### BRIEF DESCRIPTION OF THE DRAWING PORTIONS

FIG. 1 shows an exploded view of the grounding structure according to one embodiment of the present invention.

FIG. 2 shows an assembly view of the grounding structure according to one embodiment of the present invention.

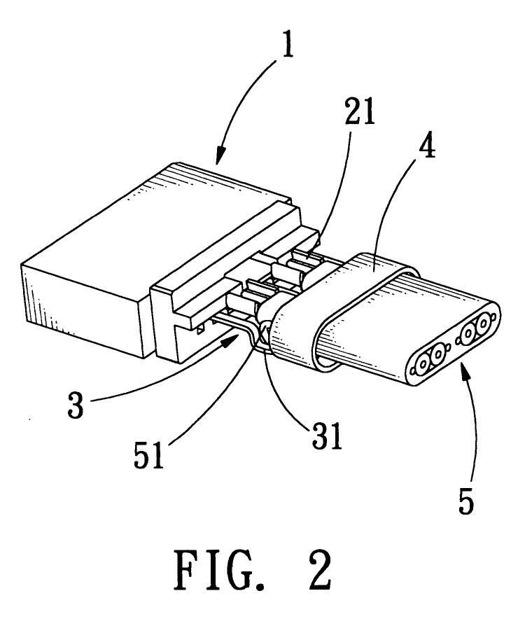

FIG. 3 shows an exploded view of the grounding structure according to another embodiment of the present invention.

FIG. 4 shows an assembly view of the grounding structure according to another embodiment of the present invention.

### DETAILED DESCRIPTION OF THE PREFERRED EMBODIMENT

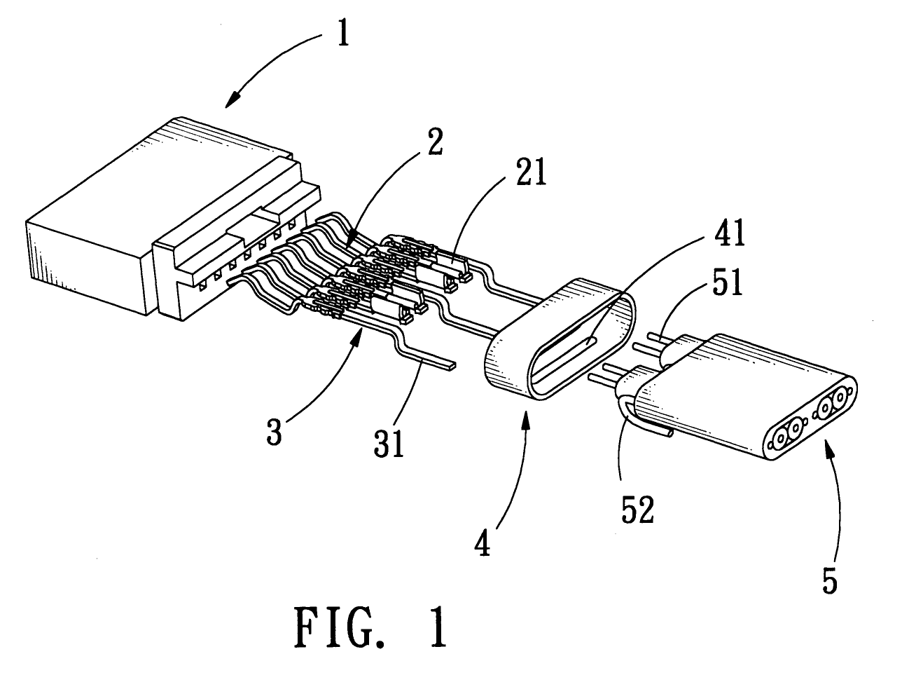

Referring to FIGS. 1˜2, which show the exploded view and assembly view of the grounding structure according to one embodiment of the present invention. As shown in the Figs., the grounding structure of the present invention mainly comprises: a housing 1; predetermined transmitting terminals 2 and grounding terminals 3 inserted inside the housing 1; a cable 5, comprising predetermined transmitting units 51 and grounding line 52; and a connecting part 4, engaging the grounding terminals 3 with the grounding line 52 to form electrical contact.

Wherein, the connecting part 4 is a sheath with electrical contact material, preferably, and it further comprises a protrusion portion 41 installed at the appropriate position to increase the contact effect and the protrusion portion 41 can be formed into a protrusion shape by the pressing process to improve the electrical contact.

As shown in Fig., the grounding structure of the present invention mainly engaged the signal transmitting units 51 with the receiving end 21 of the transmitting terminals 2 inserted inside the housing 10, and then bent the grounding line 52 (please refer to FIG. 1), finally, positioned the bent grounding line 52 and the engaging end 31 of the grounding terminals 3 over the protrusion portion 41 of the connection part 4, and then pressed and fitted tightly to the connecting part 4, such that the grounding line 52, the grounding terminals and the connecting part 4 could form electrical contact.

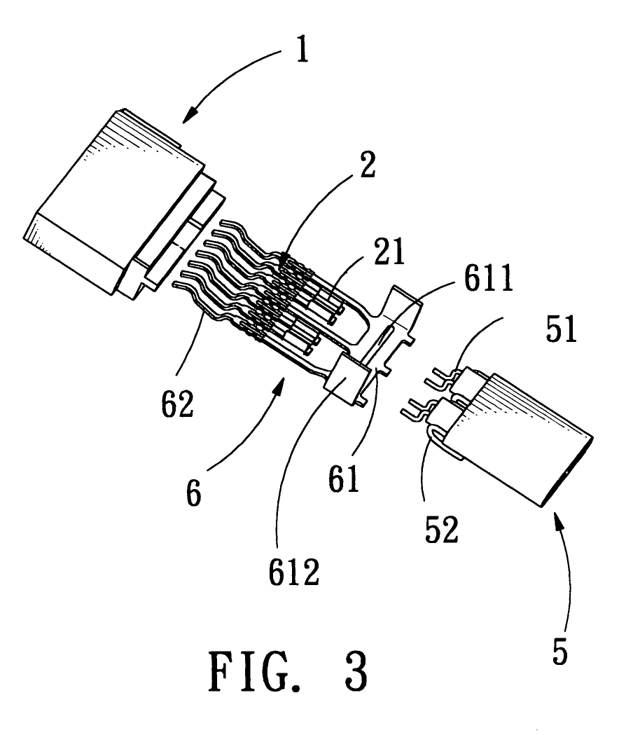

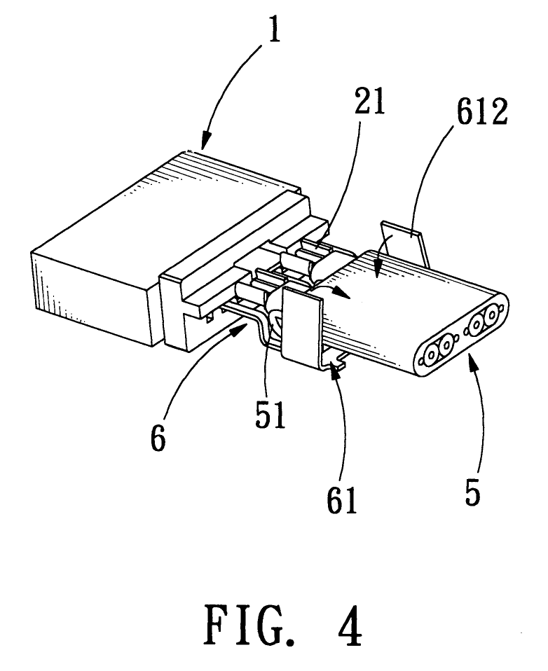

In order to prevent the grounding terminals 3 departing from the connecting part 4, please refer to FIGS. 3 and 4, which show the exploded view and assembly view of the grounding structure according to another embodiment of the present invention. As shown in the FIGS., wherein, the connecting part 6 comprises predetermined grounding terminals 62 extended directly from one end of the connecting part 6, and the other end comprises a press-fitted end 61; the press-fitted end 61 also comprises a protrusion portion 611 for electrical contacting; and both sides of the protrusion portion 611 respectively has a wing portion 612 for holding.

As shown in FIG., the grounding structure according to another embodiment of the present invention also engaged the signal transmitting units 51 with the receiving end 21 of the transmitting terminals 2 inserted inside the housing 10, and then bent the grounding line 52 (please refer to FIG. 3), finally, positioned the bent grounding line 52 over the protrusion portion 611 of the connection part 6, and then pressed and fitted inwardly and tightly the wing portions 612 of the two sides of the connecting part 6, such that the grounding line 52 and the connecting part 6 could make electrical contact.

Wherein, the connecting part 6 is made of electrical contact material; and the protrusion portion 611 also can be formed into a protrusion shape by the pressing process to improve the electrical contact.

Therefore, the connecting part of the present invention engages the grounding terminals with the grounding line of the cable securely so that the electrical connector could have better electrical performance.

Therefore, the present invention relates to a grounding structure of an electrical connector suitable for high frequency transmitting. The high frequency connector mainly has a connecting part being combined with a plurality of grounding lines to improve the electrical characteristics of the high frequency connector when it transmits signal, and the grounding line of the high frequency connector can directly be coupled to the grounding terminals without the soldering process such that the entire assembly process and the relative cost can be lessened.

Although a particular embodiment of the invention has been described in detail for purposes of illustration, various modifications and enhancements may be made without departing from the spirit and scope of the invention. Accordingly, the invention is not to be limited except as by the appended claims.

1. A grounding structure of an electrical connector, which comprises:
a housing;
predetermined transmitting terminals and grounding terminals inserted inside said housing;
a cable, comprising predetermined transmitting units and grounding line; and
a connecting part, engaging said grounding terminals with said grounding line to form electrical contact;
thereby, said connecting part engaged said grounding terminals with said grounding line of said cable securely such that said electrical connector could have better electrical performance.

2. The grounding structure of an electrical connector as claimed in claim 1, wherein said connecting part is a sheath with electrical contact material.

3. The grounding structure of an electrical connector as claimed in claim 1, wherein it further comprises a protrusion portion installed at appropriate position to increase the contact effect.

4. The grounding structure of an electrical connector as claimed in claim 3, wherein said protrusion portion can be formed into a protrusion shape by the pressing process to improve the electrical contact.

5. The grounding structure of an electrical connector as claimed in claim 1, wherein said grounding line can be bent and connected to said connecting part for increasing the contact area of said grounding line and said connecting part.

6. A grounding structure of an electrical connector, which comprises:
a housing;
predetermined transmitting terminals inserted inside said housing;
a cable, comprising predetermined transmitting units and grounding line; and
a connecting part, forced and coupled said grounding line to form electrical contact, wherein, one end of said connecting part is extended directly and has predetermined grounding terminals for inserting into said housing;
thereby, said connecting part engaged said grounding terminals with said grounding line of said cable securely such that said electrical connector could have better electrical performance.

7. The grounding structure of an electrical connector as claimed in claim 6, wherein said connecting part is made of an electrical contact material.

8. The grounding structure of an electrical connector as claimed in claim 6, wherein it further comprises a protrusion portion installed at another end to provide the electrical contact.

9. The grounding structure of an electrical connector as claimed in claim 8, wherein both sides of said protrusion portion further comprise a wing portion respectively to provide pressing and fitting.

10. The grounding structure of an electrical connector as claimed in claim 8, wherein said protrusion portion can be formed into a protrusion shape by the pressing process to improve the electrical contact.

11. The grounding structure of an electrical connector as claimed in claim 8, wherein said grounding line can be bent and connected to said connecting part for increasing the contact area of said grounding line and said connecting part.
